(19) United States
(12) Patent Application Publication
(10) Pub. No.: US 2023/0297939 A1
(43) Pub. Date: Sep. 21, 2023

(54) METHOD AND SYSTEM FOR SECURE INFORMATION SHARING

(71) Applicants: Atakan PEKER, Aliso Viejo, CA (US); Davut Kavranoglu, Istanbul (TR)

(72) Inventor: Davut Kavranoglu, Istanbul (TR)

(21) Appl. No.: 17/919,252

(22) PCT Filed: Apr. 19, 2021
(86) PCT No.: PCT/US2021/027975

§ 371 Date: Oct. 15, 2022

Related U.S. Application Data
(60) Provisional application No. 63/031,586, filed on May 29, 2020.
(60) Provisional application No. 63/022,699, filed on May 11, 2020.
(60) Provisional application No. 63/012,910, filed on Apr. 20, 2020.

(51) Int. Cl. G06Q 10/0834

(52) U.S. Cl. CPC G06Q 10/0834

(57) ABSTRACT

The invention provides a method and system for secure information sharing. An information sharing system includes a database system consisting of one or more databases working in coordination with the information sharing system configured to store one or more unique information bundles for a user. The one or more unique information bundles are generated by encapsulating/encoding a plurality of information items associated with the user. The information sharing system further includes an information sharing module configured to share one or more unique information bundles with one or more parties selectively on a need to know basis when needed. The information sharing module is further configured to share one or more Trusted Delivery Agent (TDA) IDs associated with one or more TDAs.

### CROSS-REFERENCE TO RELATED APPLICATIONS

This patent application is a US National Stage application of International PCT Patent Application No. PCT/US21/27975 to Kavranoglu, filed Apr. 19, 2021, which claims priority under 35 U.S.C. § 119 to U.S. Provisional Application No. 63012910, filed on Apr. 20, 2020, entitled “A DELIVERY SYSTEM COMPRISING TRUSTED DELIVERY AGENT”, U.S. Provisional Application No. 63022699, filed on May 11, 2020, entitled “METHOD AND SYSTEM FOR DISSEMINATION OF INFORMATION BY APPLICATION OF NEED TO KNOW PRINCIPLE” and U.S. Provisional Application No. 63031586, filed on May 29, 2020, entitled “METHOD AND SYSTEM FOR SECURE INFORMATION SHARING”, the entire disclosures of which are incorporated herein by reference in its entirety and for all purposes.

### FIELD OF THE INVENTION

The invention generally relates to a method and system for secure information sharing on a need to know basis for protection of private/confidential information. Specifically, the invention relates to an information sharing system which encapsulates/encodes all relevant information of the user and securely shares the encapsulated/encoded information on a need to know basis with one or more parties.

### BACKGROUND OF THE INVENTION

Information sharing is predominantly done in multiple sectors such as, but not limited to, delivery industries such as postal/courier industries for delivery of physical goods/parcels and services, smart cards, access control systems, ticket based systems (such as, but not limited to, cinemas, theaters, sports events, exhibition entrenches, and parking systems), payment of utility services (such as, but not limited to, electricity, gas, water, internet, paid video/TV services), hotel and rental payments (similar to Airbnb) and machine to machine (M2M) communications. For the purpose of information sharing, conventional postal address systems have been employed in the prior art for identifying users for facilitating exchange/delivery of goods and services for more than hundred years with small changes.

Existing street address conventions are built on the premise that an end user is to be identified using his location information shared for each individual shipment. The service provider does not have access to any other relevant and useful information other than the location of the end user.

The addresses are introduced naturally in different alphabets, languages and formats considering alphabet, language and cultural differences across the globe and differ based on alphabet, handwriting and language script differences. Verbal transfer of addresses is also practically impossible as it is difficult to explain addresses due to language differences.

Similarly, state-of-the-art method of sharing digital coordinates is just another method of sharing only location information, which is just a more modern version of sharing a person’s location using Global Positioning System (GPS) coordinates, rather than using street names and building numbers. The only information the person can share is his “address”, which is nothing but the user’s location. For instance, using the current system, a user cannot share available time information in a location to enable a delivery agent for a courier service to deliver parcel/shipment to the user’s location based on the user’s availability, such as, for example, the user being available at this address between 1-3 pm, so that when the courier/delivery agent arrives at that location, the user/customer is available to receive the shipment.

Furthermore, the user cannot share multiple locations with other people labeled with available time information in a scheduled manner, so that a delivery agent can make an optimal schedule to make a delivery by identifying the user’s location. Also, the existing address conventions do not allow sharing coordinates (based on GPS, GLObal NAvigation Satellite System (GLONASS), Galileo or other positioning systems) for a fixed location or a set of locations, or for continuously changing locations, three-dimensional (3D) coordinates or four-dimensional (4D) coordinates, where time is the fourth dimension.

Furthermore, data protection and privacy are important requirements in different fields where privacy of a user’s confidential or private information needs to be preserved. Considering industries such as, but not limited to, healthcare and delivery, where a user’s or customer’s information may be accessed by different parties, personal/private and confidential information are more susceptible to hacking or misuse.

In the current scenario, with the advancement of technologies, mobile devices with GPS, or other positioning systems such as, but not limited to, land-based triangulation systems or Galileo, and GLONASS and navigation capabilities and the Internet have seen widespread use and adoption. These are not a part of the address convention/standard; as such they are not being effectively used as part of shipping/receiving and delivery systems. Furthermore, there is no information sharing standard or system exploiting these technologies effectively in delivery and logistics systems and securely sharing relevant/useful information with concerned parties.

The address convention used in many industries and governmental operations use a hierarchal convention based on describable milestones and benchmarks predefined by either local authorities, political borders or personal markings such as, but not limited to, streets, provinces, cities and countries. In address conventions for different political entities, the convention varies based on elements of the address and its hierarchy. The address conventions generally target and address a small area, or a building and its smallest part belong to a specific unit that can be assigned attributes such as, but not limited to, a street name and a building number. For example, a door number of a flat unit in a building is labeled by a number starting from the 1^{st} flat unit and developing numbers in an increasing manner as a spiral schema turning from left to right in some countries whereas in other countries it turns from right to left. In some conventions, the street names must be accompanied by a postal code. Further, these forms of convention and formats are not processable by digital delivery equipment and cannot address the location in such granularity for not only two-dimensional descriptions but for the third dimension as well.

In view of the above, there exists a need to address the drawbacks of existing address conventions and provide a system for securing sharing information related to a user.

Furthermore, the delivery services, or courier services or package/parcel delivery services are part of an industry segment called the delivery industry, which primarily engages in delivery services of packages and/or parcels between urban centers, and to a limited extent covering rural areas as well, using a network of air, sea and surface transportation systems. The delivery industry has been one of the most crucial enabling industries for development of international trade and direct to consumer sales in the world. Especially after the beginning of the Internet age starting from early 1990s, people around the world enjoy the conveniences brought by the Internet for shopping and receiving other services online.

The natural result of online shopping is a fast-increasing demand for the delivery of parcels from online sellers to buyers, where the delivery industry acts as an enabler for the online shopping companies. Online shopping companies are increasingly playing a more direct role in delivery services not only to meet their delivery needs but also to have a competitive advantage by differentiating their overall services and offerings.

A particular problem of the delivery industry is the limitation involved in sharing user identity and information needed to facilitate exchange/delivery of goods and services. Delivery information generally involves identifying a user using basic personal information such as the user’s phone number, credit card information and postal address. This information is manually provided by the user to a courier service provider and is disclosed to a chain of delivery agents. The courier service provider then delivers the goods or services based on the information shared by the user.

In the delivery industry, items or products ordered via an electronic commerce system are generally shipped to an intended receiver or a purchaser using delivery services such as, but not limited to, carrier/courier services and/or postal services. During the delivery of shipments, contact information of the receiver, including a shipping address, contact number or other personally identifiable information is often communicated to the carrier/courier service to facilitate delivery of the shipment to the receiver. This information is often placed on a shipping label affixed to the shipment/parcel to enable courier personnel to contact the receiver in these situations.

Additionally, for the delivery of shipments in an electronic commerce system, a carrier or courier service may often employ a chain of intermediary agents from the point of receiving the shipment, through its transit and finally to the intended destination for delivery to the receiver. Accordingly, this mode of delivery may require that the receiver’s entire contact information be disseminated through the chain of intermediary agents.

Therefore, in the context of delivery of such information with possible accompanying shipment, maintaining privacy of the receiver’s information is highly desirable. A typical shipment delivery process is illustrated in the following example.

Consider a receiver places an order from a seller for some goods and completes the transaction for the goods. A courier company is then engaged by the seller or the receiver to pick up the shipment from the seller and deliver it to the receiver. Information such as, but not limited to, a pickup location of the shipment, the receiver’s shipping address along with other contact details are communicated to the courier company. The shipping address indicates the country, state, city/town of the receiver. From this information, the courier service knows from where they should pick up the shipment and an entry point to reach the receiver in the receiver’s country, if the courier service flies into more than one airport in that country.

During this entire process, the address information of the receiver is shared with all the intermediary agents, from the beginning to the end of the chain, thus compromising on privacy of the receiver’s information to many intermediary parties unnecessarily. Even if the receiver’s entire information is sent throughout the delivery chain of agents and information unmasking is done using existing encryption algorithms, this would still risk private information being exposed as these encryption algorithms may be hacked or forced to be revealed to a foreign law enforcement.

Therefore, there exists a need for an improved method and system for sharing information on a need to know basis by providing just enough information to enable concerned parties to carry out their service to a user/consumer in an efficient manner.

Furthermore, the delivery industry encounters issues such as the First Mile and the Last Mile problem as illustrated in FIG. 1 and FIG. 2 respectively, which is a significant cost element for the delivery industry.

Referring to FIG. 1, the First Mile delivery is the initial stage of transportation/delivery in the consumer-to-consumer (C2C) logistics supply chain and the business-to-consumer (B2C) logistics supply chain. In the First Mile delivery of the C2C and B2C logistics supply chain, shipments or parcels are picked up from a consumer or the retailer and are dropped off at a carrier facility such as, but not limited to, freight services (for example, truck, train, ship, or aircraft), post office or the mailbox. The carrier facility then transports the shipments/parcels to a transfer point where they are picked up and transported to distribution centers. This completes the First Mile delivery process. The biggest problem in the First Mile delivery is encountered when erroneous or incomplete information is provided by a consumer or a retailer for completing the delivery of shipments/parcels to a recipient. This problem is further exacerbated due to incorrect labels on the shipments/parcels. This may result in the shipments/parcels being delivered to wrong distribution centers and in the process may not reach the correct destination address of the recipient or may result in excessive delays for completing the delivery. Similarly, the First Mile problem amplifies the difficulty of picking up parcels from consumers for delivery to a recipient, in case of long-distance deliveries and incorrect recipient details being shared with a service provider.

Referring to FIG. 2, the Last Mile problem can be simply explained as follows: When a package or parcel is shipped from its origination point to its final delivery point at the receiving party which is possibly thousands of miles away from its origination point, significant cost is incurred to deliver the parcel. It is well known in the delivery industry that a significant portion of the entire shipping cost is incurred in the very last part of the delivery process, where the courier companies are trying to identify the exact location of a receiving party (recipient) and identify an authorized party to complete the delivery process for each of the hundreds of millions of packages every day around the world. Also, even if courier agents find the exact location of the recipient, the recipient may not be present in their location at the time of delivery attempt, in which case, the delivery must be re-tried the following day. Since there is no information other than location information, the availability time in that location cannot be communicated to the courier agent. This problem is called the ‘Last Mile Problem’ and this is where courier companies are struggling to cut down the cost and increase customer satisfaction.

It should also be noted that as the standard of living increases, people increase amount and the variety of their online shopping, that is, people buy books, white goods, and even daily groceries online. There is also an increasing trend that people are willing to pay extra for the goods to be delivered as soon as possible, even on the same day of the purchase. This is called the same day delivery problem and the demand for it is also increasing significantly.

Also, another related and important problem is that to make use of the conveniences brought by the Internet, the consumers are left with no solution but to give out their personal and financial information to others. The sellers and courier services obtain the personal or private information such as, but not limited to, credit card information and address information.

All these challenges and customer expectations are drivers for the delivery industry to find new systems of delivery where the First Mile and the Last Mile delivery cost can be reduced, and customer privacy and satisfaction are increased.

Therefore, there exists a need for an improved information sharing system for securely sharing relevant private information of a user only on a need to know basis for each recipient or for the purpose of facilitating delivery/exchange of messages, goods, or services or sharing information for other purposes not necessarily listed here. Furthermore, there exists a need for an improved delivery system which addresses the aforesaid challenges/issues of the delivery industry while ensuring secure delivery of products and services to a consumer/recipient.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a schematic representation of the First Mile problem in the delivery industry.

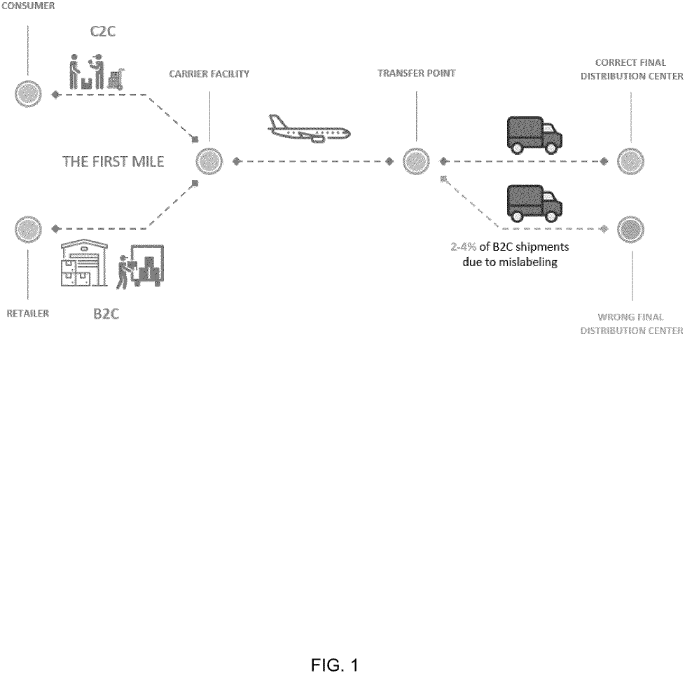

FIG. 2 is a schematic representation of the Last Mile problem in the delivery industry.

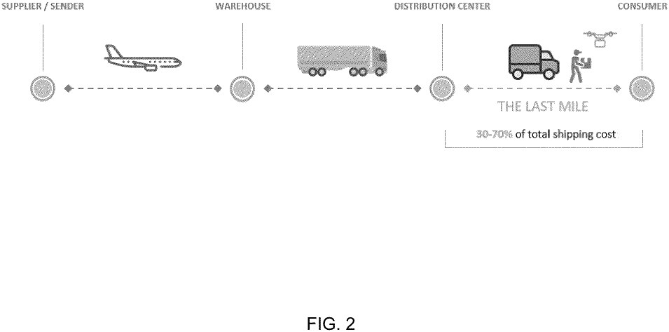

FIG. 3 illustrates an information sharing system for secure information sharing in accordance with an embodiment of the invention.

FIG. 4 illustrates a structure of an information wallet in accordance with an embodiment of the invention.

FIG. 5 illustrates different share options for enabling a recipient to access different subsets of information items residing within a unique information bundle in accordance with an embodiment of the invention.

FIG. 6 illustrates a flowchart of a process for secure information sharing using the information sharing system in accordance with an embodiment of the invention.

FIG. 7 illustrates a delivery chain network for delivery of a shipment to a receiver in accordance with an exemplary embodiment of the invention.

FIG. 8 illustrates a system for dissemination of information pertaining to the receiver in the delivery chain network in accordance with an exemplary embodiment of the invention.

FIG. 9 illustrates a need to know principle-based encryption algorithm used in conjunction with a need to know basis delivery protocol in accordance with an exemplary embodiment of the invention.

FIG. 10 illustrates hierarchical dissemination of an address/location information of the receiver in accordance with an exemplary embodiment of the invention.

FIG. 11 illustrates algorithmic steps for dissemination of information pertaining to a receiver in a shipment company delivery chain in accordance with an exemplary embodiment of the invention.

FIG. 12 illustrates a flowchart of a process for dissemination of information pertaining to a user on a need to know basis while providing a service to the user in accordance with an embodiment of the invention.

FIG. 13 illustrates a delivery system for facilitating delivery of products/services to a user in accordance with an embodiment of the invention.

FIG. 14 illustrates a schematic depiction of a Trusted Delivery Agent (TDA) in accordance with an embodiment of the invention.

FIG. 15 illustrates a schematic depiction of a TDA as the First Mile and Last Mile solution in accordance with an exemplary embodiment of the invention.

FIG. 16 illustrates a TDA solution in a delivery network in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the invention, it should be observed that the embodiments reside primarily in combinations of method steps and system components which encapsulate/encode all relevant information of the user and securely share the encapsulated/encoded information on a need to know basis with one or more parties.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Various embodiments of the present invention disclose an information sharing system for secure information sharing. The information sharing system includes a database system consisting of one or more databases working in coordination with the information sharing system. The database system is configured to store one or more unique information bundles for a user. The one or more unique information bundles are generated by encapsulating/encoding a plurality of information items associated with the user. The plurality of information items include, but need not be limited to, basic contact information of the user, the user’s images/photos, 3D/4D addresses/coordinates of the user’s location, the user’s biometrics information, images/pictures of the user’s location, building, entrance/door, pictures/videos of the location/landmarks/way points to the user’s location, navigational aids, information about proxy contacts of the user to reach out to in case of difficulty, barcodes, square codes, Trusted Delivery Agent (TDA) IDs and Radio Frequency (RF) IDs, and an available time or schedule of the user. The one or more unique information bundles are stored in an information wallet.

The information wallet refers to an information sharing account of the user. The user’s information sharing account is associated with a unique name for sharing an identity of the user (such as, for example, @johndoe). An information sharing identity can also be considered as a unique name for the information wallet. The user can store own unique information bundles in the information wallet to be shared with other users, or the information wallet can also store information bundles shared with the user by other users.

In accordance with another embodiment, one or more information items of the plurality of information items associated with a unique information bundle are updated based on tracking the user’s current location.

The information sharing system further includes an information sharing module configured to share one or more unique information bundles with one or more parties. The one or more parties can be, but need not be limited to, service providers, delivery agents, TDAs, other users, non-users and machines. Further, the information sharing module is configured to enable dissemination of information resident within a unique information bundle selectively when needed.

In accordance with an embodiment, the information sharing module is configured to share one or more information items encapsulated/encoded in a unique information bundle with the one or more parties.

In accordance with another embodiment, the information sharing module is configured to disseminate only a portion of an information item encapsulated/encoded in a unique information bundle on a need to know basis to each of the one or more parties. The information item, in this case, can be, but need not be limited to, a postal address.

In accordance with yet another embodiment, the information sharing module is configured to share an “Interactive Address”/“Connected Address”/“Live Address” with one or more parties. The “Interactive Address”/“Connected Address”/“Live Address” includes a scheduled (time-based) information and/or an updated location information.

In accordance with various other embodiments, the present invention is directed to a system of package and parcel delivery process and more specifically directed to a system to remedy the so-called Last Mile and First Mile problem in the delivery industry.

This invention is based on a network of Trusted Delivery Agents (TDA, for short) that are appointed by the consumers to make their final deliveries for them. The delivery system further comprises a system of identity sharing, which is formed for the consumers. In this system, the consumers identify themselves uniquely by selecting “TDAs” in their neighborhood. Ordinarily, these TDAs are existing neighborhood small businesses that the consumers customarily utilize for their daily needs, such as, but not limited to, a neighborhood grocery store, a gas station, a bakery, or a store started up just to serve as TDA. The consumer’s exact delivery information is made available to the TDA or the TDA naturally has such knowledge about the consumer since they are in the same neighborhood. A system is built to enable a solution to solve the Last Mile problem. The system utilizes the TDA network to provide a solution and remedy the inefficiencies and difficulties.

In one embodiment of the invention, a delivery system comprises a network of TDAs selected from ordinary neighborhood businesses, where the delivery system enables TDAs to serve as the Last Mile delivery agent for courier companies.

In another embodiment of the invention, a delivery system comprising TDAs provides a solution for the Last Mile delivery problem for the parcel delivery industry, wherein the TDAs are primarily selected by the recipient consumers and not by the delivering courier services.

In another embodiment of the invention, a delivery system comprising TDAs provides a solution for the Last Mile delivery problem for the parcel delivery industry.

In another embodiment of the invention, a delivery system comprising TDAs provides a solution for the same day delivery problem.

In another embodiment of the invention, a delivery system comprising TDAs enables money transfer or cash delivery from their banks to the consumers or from consumers to consumers.

In another embodiment of the invention, a delivery system comprising TDAs replaces the ATM cash delivery system for the banks.

A particular objective of the present invention is a delivery system comprising a network of Trusted Delivery Agents (TDA), that are appointed by the consumers to make their final deliveries for them. The delivery system further comprises a system of identity sharing which is formed for the consumers. In this system, the consumers identify themselves uniquely by selecting “TDAs” in their neighborhood. Ordinarily, these TDAs are existing neighborhood small businesses that the consumers customarily utilize for their daily needs, such as, but not limited to, a neighborhood grocery store, a gas station, a bakery, or a store started up just to serve as TDA. The consumer’s exact delivery information is made available to the TDA or TDA naturally has such knowledge about the consumer since they are in the same neighborhood. As such the delivery system is built to enable a solution to solve the Last Mile problem. The delivery system utilizes the TDA network to provide the solution and remedy to the Last Mile problem.

A delivery system of the current invention has the following key elements: a system of identity sharing, a TDA, and a communication and delivery protocol among the delivery courier services, the recipient, and the TDA.

An exemplary embodiment of the current invention can be summarized as follows:

The consumers ask the courier companies for their packages to be delivered to a “final address”, which are TDAs. The courier company makes final deliveries to the very same TDAs every day, hence no time consuming need to search for the location and person for the delivery of each and every package.

During the execution of an online purchase and shipping process three contracts are entered into:
1- The contract between the consumer and the online seller. This contract includes the item purchased and corresponding payment to be made and allowing the courier company to pick up the package after the payment is done. Unless the consumer returns the purchased goods for some reason, the contract is fulfilled when the package is delivered to the courier company.
2- The contract between the consumer and the courier company. This contract includes picking up the package from the seller (or the sender in case it is a consumer-to-consumer shipment) after the ordering consumer makes the payment. The contract is fulfilled when the courier company delivers the package to the TDA of the consumer.
3- The contract between the consumer and TDA. This contract indicates that TDA receives the goods from the courier company on behalf of the consumer and is responsible for the well-being of the package after it is received by them. The TDA’s contract is fulfilled when the consumer either picks up the package from the TDA or the TDA delivers the goods to the consumer upon their request through the system.

As soon as the package is delivered to the TDA, the courier company fulfills its “contract” with the consumer for delivery since the consumer asked for the delivery to be made to the TDA. At that moment, the consumer is messaged through the system that their package has been delivered to the TDA as per their demand. The consumer can opt to ask the TDA to deliver the package to their location, which is known by the TDA or the consumer can go and pick up the package from the TDA. At this stage of the delivery process the “contract” between the TDA and the consumer is in effect. All of these contacts are entered into through the system of the present invention.

TDAs could be utilized for delivery of things other than parcels, such as delivery of cash from a consumer’s bank account to the consumer or from one consumer to another consumer where each consumer could possibly be served by different TDAs in the system around the world. Such a system would transform the concept of money transfer or ATM services offered by banks. Going to an ATM machine to get cash would be replaced by delivery of needed cash through the system utilizing the TDA network.

As such in one embodiment of the invention, a delivery system has the following steps:
a-The recipient creating and establishing a unique identification code.
b-The recipient selecting and entering a TDA into the delivery system.
c-The selected TDA is established in the delivery system per the system protocols.
d-The delivery courier is notified to deliver the packages to the TDA for packages destined for the recipient.

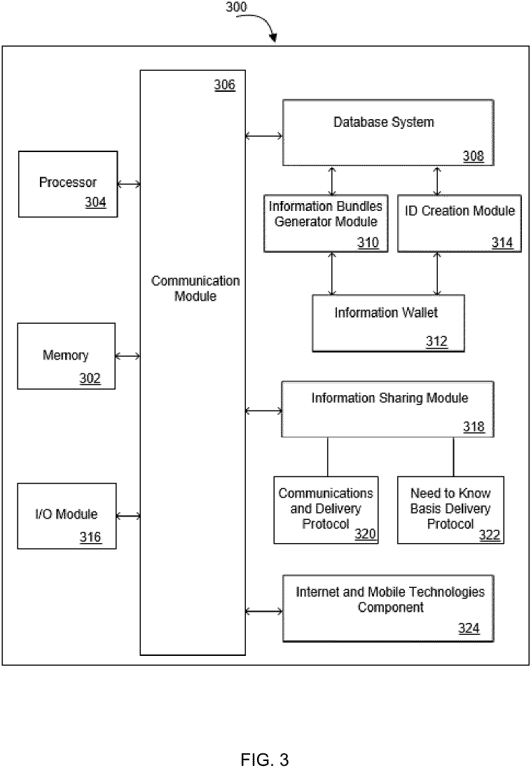

FIG. 3 illustrates an information sharing system 300 for secure information sharing in accordance with an embodiment of the invention.

As illustrated in FIG. 3, information sharing system 300 includes a memory 302 and a processor 304 communicatively coupled to memory 302. Memory 302 and processor 304 further communicate with various modules of information sharing system 300 via a communication module 306.

Communication module 306 may be configured to transmit data between modules, engines, databases, memories, and other components of information sharing system 300 for use in performing the functions discussed herein. Communication module 306 may include one or more communication types and utilizes various communication methods for communication within information sharing system 300.

In an embodiment, information sharing system 300 can be downloaded as an application on a user’s computing device which can be, but need not be limited to, a mobile device, a smartphone, a laptop, a computer, and a tablet or other virtual machines or embedded devices.

Referring to FIG. 3, information sharing system 300 includes a database system 308 which includes one or more databases working in coordination with information sharing system 300. Various versions of database system 308 can be implemented without limiting the scope in context of information sharing system 300.

Database system 308 is configured to store one or more unique information bundles of a user. Information sharing system includes an information bundles generator module 310 which enables generating the one or more unique information bundles for the user by encapsulating/encoding a plurality of information items associated with the user into a ‘short code’. The user can be, but need not be limited to, a customer, a service provider such as, but not limited to, a courier/postal/delivery service provider and a seller/vendor.

The plurality of information items include, but need not be limited to, basic contact information of the user, the user’s images/photos, 3D/4D addresses/coordinates of the user’s location, the user’s biometrics information, images/pictures of the user’s location, building, entrance/door, pictures/videos of the location/landmarks/way points to the user’s location, navigational aids, information about proxy contacts of the user to reach out to in case of difficulty, barcodes, square codes, TDA IDs and Radio Frequency (RF) IDs, and an available time or schedule of the user.

In accordance with an embodiment, the one or more unique information bundles are stored in an information wallet 312 under a unique information identifier (ID) that is created using an ID creation module 314. Information wallet 312 refers to an information sharing account of the user. The user’s information sharing account is associated with a unique name for sharing an identity of the user (such as, for example, @johndoe). An information sharing identity can also be considered as a unique name for information wallet 312. The users can store their own unique information bundles in information wallet 312 to be shared with other users, or information wallet 312 can also store information bundles shared with the user by other users.

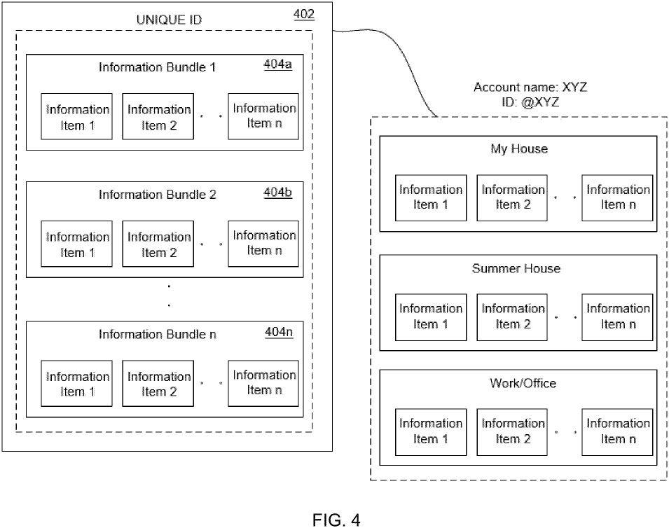

In accordance with an embodiment, information bundles generator module 310 generates the one or more unique information bundles for the user to be stored in information wallet 312 based on all relevant information received from the user via an input/output (I/O) module 316. The structure and further details pertaining to information wallet 312 are illustrated in conjunction with FIG. 4.

Information sharing system 300 further includes an information sharing module 318 which is configured to share one or more information bundles of the user with one or more parties. The one or more parties can be, but need not be limited to, service providers, delivery agents, TDAs, other users, non-users and machines. Information sharing module 318 is configured to enable dissemination of information resident within a unique information bundle selectively when needed. Information sharing module 318 is further configured to share one or more information items of the plurality of information items encapsulated/encoded in a unique information bundle with the one or more parties.

In accordance with an embodiment, information sharing module 318 includes a communications and delivery protocol 320 which is configured to share one or more information items encapsulated/encoded in a unique information bundle with the one or more parties.

For instance, communications and delivery protocol 320 is configured to share an “Interactive Address” or “Connected Address” or “Live Address” with the one or more parties such as, but not limited to, service providers. This enables the service providers to have scheduled (time-based) or updated location information from an ID owner whenever appropriate through information sharing system 300. This also enables the service providers reach the location of the user based on the provided availability information. Furthermore, information sharing system 300 enables both the consumers and service providers to update the shared information when required using I/O module 316.

Similarly, continuously changing location information is instantaneously shared using communications and delivery protocol 320 to provide “Live Address or Connected Address” to enable services such as “delivery on the move”, where the consumer is not in a fixed location, and is on the move. Such a property is used in applications such as, but not limited to, smart cars, smart traffic or coordinated land base or airborne traffic applications.

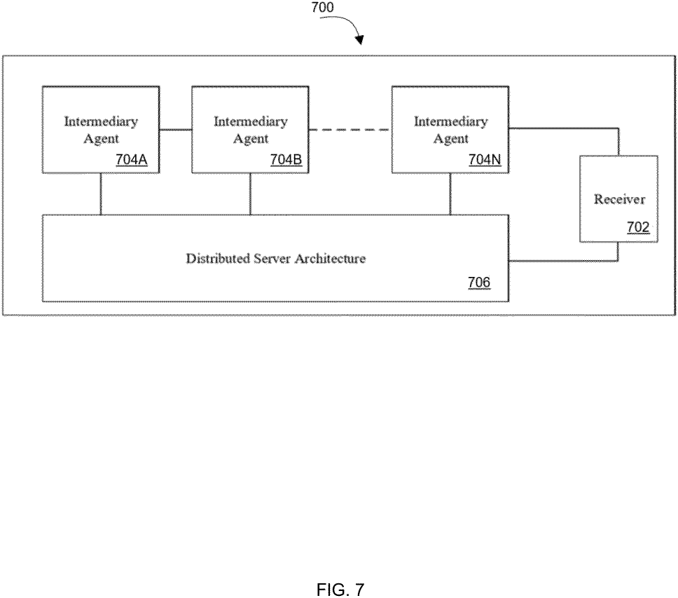

In accordance with another embodiment, information sharing module 318 includes a need to know basis delivery protocol 322 which is configured to disseminate only a portion of an information item encapsulated/encoded in a unique information bundles on a need to know basis with each of the one or more parties. Thus, need to know basis delivery protocol 322 enables hierarchical dissemination of the information for effective completion of services or tasks. Further details pertaining to need to know basis delivery protocol 322 are illustrated in detail in conjunction with FIGS. 7, 8, 9, 10, 11 and 12.

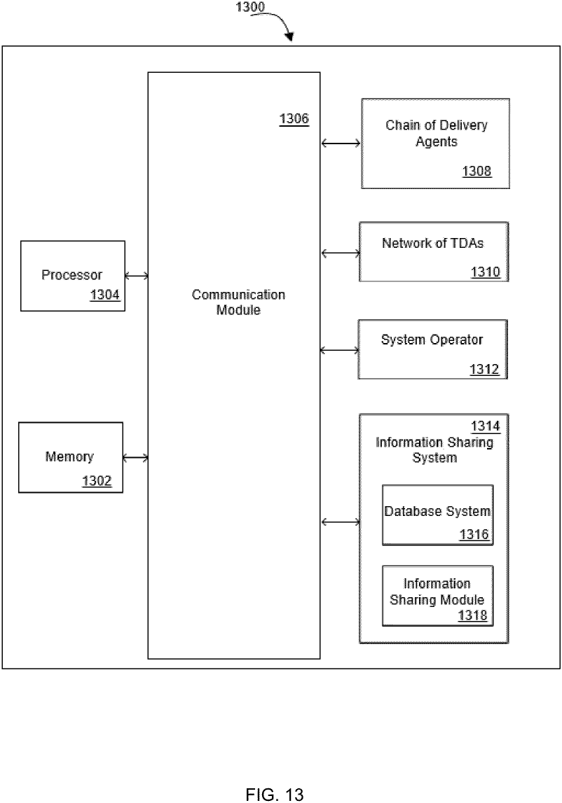

In accordance with yet another embodiment, the relevant information shared using information sharing module 318 are the IDs of TDAs. For instance, if a customer is using a TDA for delivery of a shipment, the customer will not need to share any other information other than the TDA’s ID with information of where the customer wants the delivery to be made. A TDA is selected by the user from a network of TDAs. The network of TDAs is selected from a group consisting of, but not limited to, neighborhood small businesses, a household, mobile distribution network, and any local qualified party willing to be assigned as TDA, to enable either a First Mile or Last Mile delivery. Further details pertaining to TDAs are described in detail in conjunction with FIGS. 13, 14, 15 and 16.

In accordance with still yet another embodiment, the relevant information shared using information sharing module 318 is the mailbox number or a drop-in location.

Information sharing system 300 also includes an internet and mobile technologies component 324 in communication with GPS and navigation capabilities of the user’s computing device for tracking the user’s current location and automatically updating one or more information items associated with the one or more unique information bundles. The user can also manually update any information associated with the one or more unique information bundles of the user’s account via I/O module 316. Thus, the one or more unique information bundles are unique to a user and not to the user’s location.

FIG. 4 illustrates a structure of information wallet 312 in accordance with an embodiment of the invention.

As illustrated in FIG. 4, information wallet 312, under a unique ID or unique name 402, stores one or more unique information bundles 404a-404n. Information wallet 312 refers to an information sharing account of the user. The user’s information sharing account is associated with a unique name for sharing an identity of the user. Each information bundle of one or more unique information bundles 404a-404n stores one or more information items. For instance, referring to FIG. 4, every user has a unique ID, such as @XYZ, and has a personal ID account. Under the personal account the user forms unique information bundles such as, but not limited to, “My House”, “Summer House”, “Work/Office”, which comprise one or more information items ready to be shared with others.

In accordance with an embodiment, a unique ID or unique name may be automatically generated using techniques/devices such as, but not limited to, a random number generator using personally identifiable information (PII) of the user such as, but not limited to, name, phone number, and date of birth.

In accordance with another embodiment, ID creation module 314 generates a random session code as the unique ID or unique name to anonymize the identity of the user to hide his identity and to prevent profiling of the user (name owner).

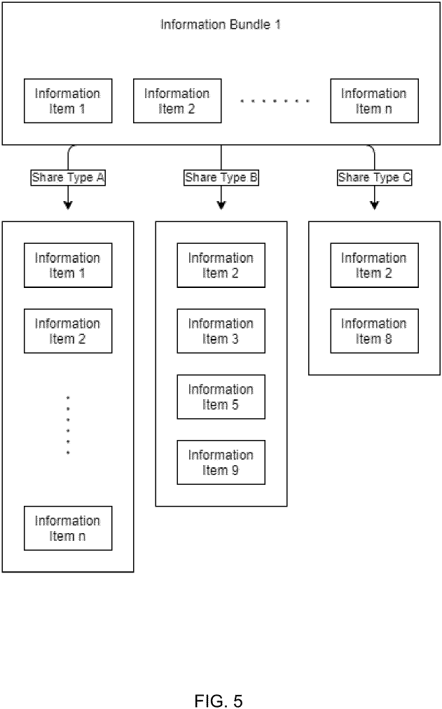

FIG. 5 illustrates different share options for enabling a recipient to access different subsets of information items residing within a unique information bundle in accordance with an embodiment of the invention as an example of need to know basis information sharing.

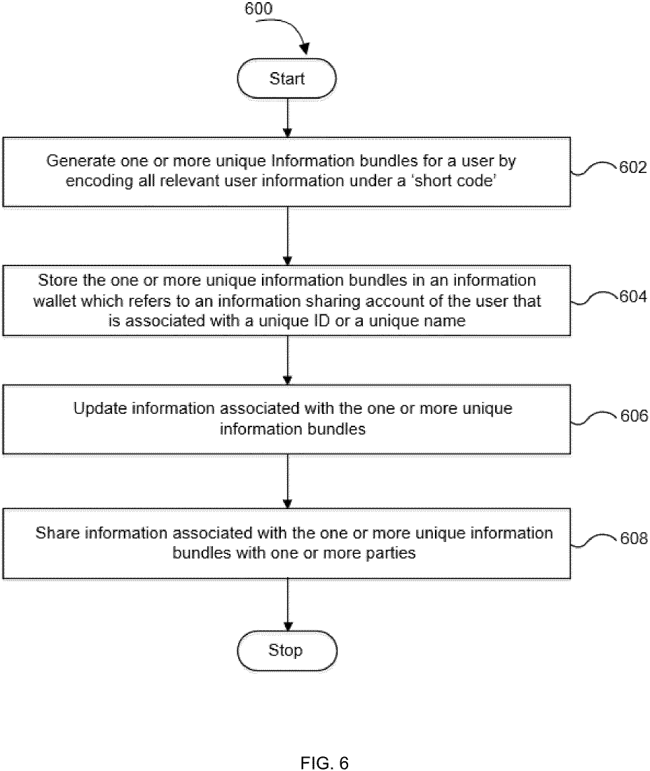

FIG. 6 illustrates a flowchart of a process 600 for secure information sharing using information sharing system 300 in accordance with an embodiment of the invention.

As illustrated in FIG. 6, at step 602, information bundles generator module 310 generates one or more unique information bundles for a user based on all relevant information received from the user. Information bundles generator module 310 generates the one or more unique information bundles by encoding all relevant information of the user under a ‘short code’, thus generating identity information for the user.

In an ensuing step 604, the one or more unique information bundles are stored in information wallet 312 which refers to an information sharing account of the user that is associated with a unique ID or unique name.

At step 606, the information associated with the one or more unique information bundles may be updated using I/O module 316. For instance, the user’s address information associated with the one or more unique information bundles is automatically updated using internet and mobile technologies component 324 which is in communication with the GPS and navigation capabilities of the user’s computing device for tracking the user’s current location. The user can also manually update any information associated with the one or more unique information bundles using I/O module 316.

Finally, at step 608, using information sharing module 318, the information associated with the one or more unique information bundles is securely shared with one or more parties.

The following embodiments in particular describe information sharing on a need to know basis in the context of a delivery network.

FIG. 7 illustrates a delivery chain network 700 for delivery of a shipment to a receiver 702 in accordance with an exemplary embodiment of the invention.

As illustrated in FIG. 7, delivery chain network 700 includes a plurality of intermediary agents 704A-704N for facilitating delivery of the shipment to receiver 702. Delivery chain network 700 can be, but need not be limited to, a carrier or courier service, a shipment service, and a postal service. The shipment may include physical goods such as, but not limited to, mail, parcel, documents, cash payments, precious metals, and the like. Plurality of intermediary agents 704A-704N are connected in a distributed server architecture 706.

In the context of an electronic commerce purchase/order and transaction, a third-party service provider/seller or the purchaser itself reveals information pertaining to receiver 702 to delivery chain network 700. This information includes, but is not limited to, receiver 702′s location or postal address (country, state, city/town, state, and postal code), and personally identifying information such as, but not limited to, name, available time information for deliveries and telephone number. In some cases, the purchaser is receiver 702 who orders/purchases goods on an electronic commerce site. Further, delivery chain network 700 is provided the pickup location of the shipment for delivery to receiver 702.

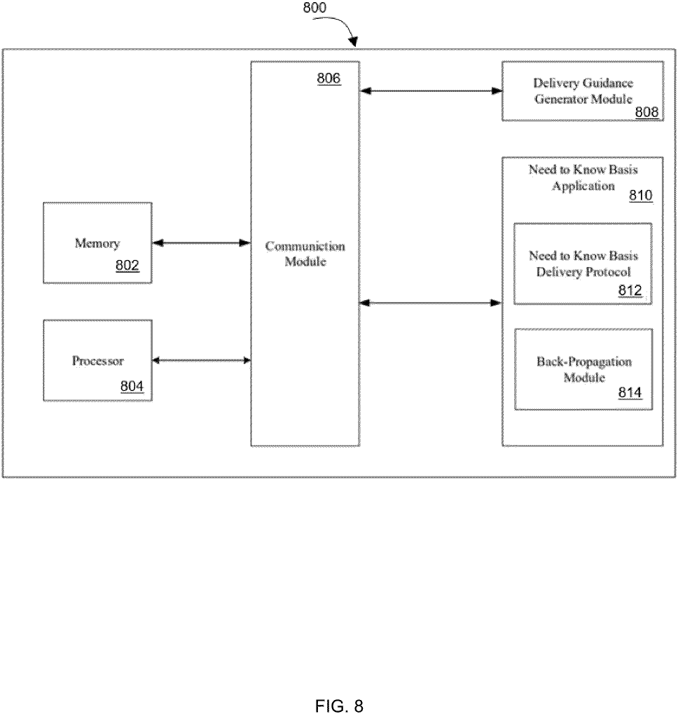

FIG. 8 illustrates a system 800 for dissemination of information pertaining to receiver 702 in delivery chain network 700 in accordance with an exemplary embodiment of the invention.

As illustrated in FIG. 8, system 800 includes a memory 802 and a processor 804 communicatively coupled to memory 802. Memory 802 and processor 804 further communicate with various modules of system 800 via a communication module 806.

Communication module 806 may be configured to transmit data between modules, engines, databases, memories, and other components of system 800 for use in performing the functions discussed herein. Communication module 806 may include one or more communication types and utilizes various communication methods for communication within system 800.

System 800 includes a delivery guidance generator module 808 which generates delivery guidance information based on information received from receiver 702 and the delivery guidance information is disseminated across plurality of intermediary agents 704A-704N of delivery chain network 700 in a hierarchical manner using a need to know basis application 810. Need to know basis application 810 further includes a need to know basis delivery protocol 812 for securely disseminating information across plurality of intermediary agents 704A-704N on a need to know basis.

The delivery guidance information can include details such as, but not limited to, location/address information and phone number of receiver 702, an available time of receiver 702 to receive shipments during the day and other relevant information. At every stage, the delivery guidance information is shared on a need to know basis using need to know basis delivery protocol 812.

In an embodiment, need to know basis application 810, at receiver 702′s end, generates information required for each intermediary agent and provides only that information to those agents. Since the information is revealed in a controlled and secure manner, the information cannot be hacked. Even if the information is hacked, the server of an intermediary agent obtains very little information about a consumer (receiver 702, in this case), and a foreign law enforcement system will not have access to any private information about any foreign person.

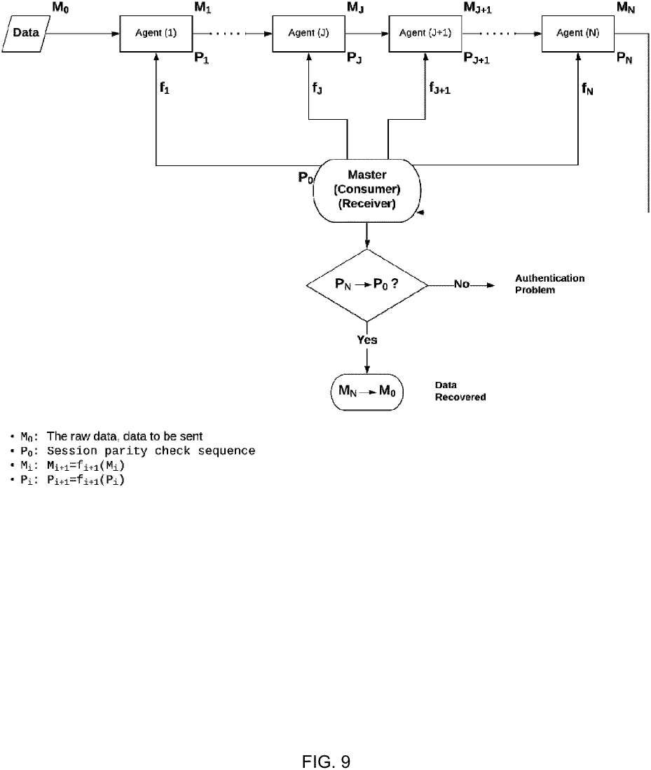

Need to know basis delivery protocol 812 further enables, at each stage, each intermediary agent of plurality of intermediary agents 704A-704N, to authenticate the information from the beginning to their level. The intermediary agent then embeds its authentication in the information. In an exemplary implementation, the intermediary agent signs the information by embedding their own digital signature for authentication. In another exemplary implementation, need to know basis delivery protocol 812 provides an authentication method between any two agents using a parity check between any two agents. This may include, but need not be limited to, use of random number generators that are synchronized between any two agents. An encryption algorithm used in collaboration with need to know basis delivery protocol 812 for authentication is described in detail in conjunction with FIG. 9.

The information is then transmitted to the next intermediary agent as per the delivery guidance information via need to know basis delivery protocol 812.

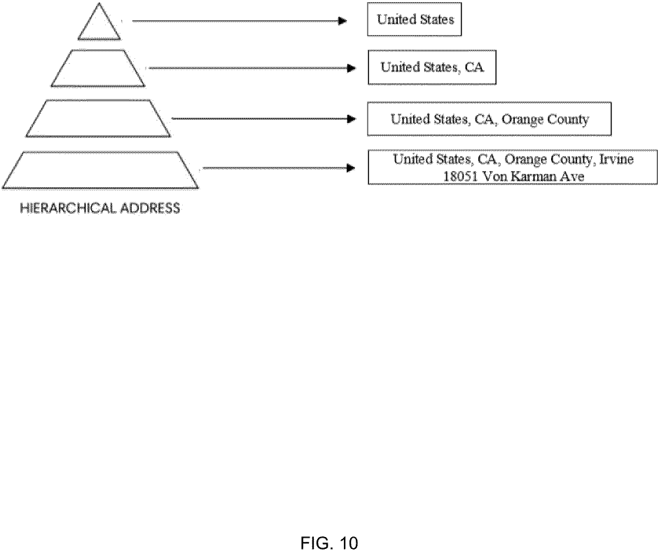

In an embodiment, the address/location information of receiver 702 is disseminated in a hierarchical manner across plurality of intermediary agents 704A-704N using need to know basis delivery protocol 812. This is further illustrated in detail in conjunction with FIG. 10.

Finally, upon the shipment reaching receiver 702, need to know basis delivery protocol 812 authenticates the information or the shipment and receiver 702 embeds their authentication information by signing it with their digital signature. The delivery process ends upon receiving the acknowledgement of the authenticated information or shipment from receiver 702.

In some embodiments, a sender may be informed of the delivery through delivery chain network 700 in a back-propagation manner via a back-propagation module 814 of need to know basis application 810, through the same plurality of intermediary agents 704A-704N in a hierarchical manner. Thus, the acknowledgment of the final delivery information is provided on a “need to know basis” without ever sharing receiver 702′s private information with any one of plurality of intermediary agents 704A-704N.

At any stage, if there is any problem about the authenticity of the information or the shipment, plurality of intermediary agents 704A-704N are probed using back-propagation module 814 to identify the point where a problem occurred. Such a chain of authentication may stop any further steps and revert to the previous level, which had been the source of the problem.

FIG. 9 illustrates a need to know principle-based encryption algorithm used in conjunction with need to know basis delivery protocol 812 in accordance with an exemplary embodiment of the invention.

As illustrated in FIG. 9, in the need to know principle-based encryption algorithm, every agent is assigned a session fᵢ that maps the input sequence to an output sequence in a reversible manner as illustrated below.

| | | | |
|---|---|---|---|
| α₁ | α₂ | ...... | αᵣ |
| β₁ | β₂ | ...... | βᵣ |

| α₁ α₂ α₃ α₄ | β₁ β₂ β₃ β₄ |
|---|---|
| (3, 1, 4, 2) | (4, 3, 2, 1) |

Referring to the above, there are r! possible input-output mappings for each Agent’s operation. Every Agent is provided information about who the previous and next Agents are. The first Agent and the last Agent are informed of their status and N is known only to the Master (consumer), where N > 1.

Referring to FIG. 9, a data M₀ is encrypted and transmitted to the consumer using a distributed need to know basis agent protocol. Consider that the length of the data (M₀) is a multiple of r (otherwise pad enough zeros at the end of the sequence and write the number of padded zeros as the last character(s)).

Agent_{(J+1)} receives the data Mⱼ and parity sequence P_{J} as the output of Agent_{J}.

Agent_{(J+1)} applies f _{(J+1)} to Mⱼ and P_{J}. Then,

$${\text{P}}_{\text{J}} {\text{+1 = f}}_{\text{J}} + 1 \left({\text{P}}_{\text{j}}\right)$$

$${\left({\text{M}}_{\left(\text{J+1}\right)} = {\text{f}}_{\text{J}} + 1 \left({\text{M}}_{\text{j}}\right) = \left[{\text{f}}_{\text{J}} \text{+1} \left({\text{M}}_{\text{j}} \text{, i}\right)\right]\right|}_{i = 1}^{\frac{N}{r}}$$

[image]

wherein Mj divided is into blocks of length r;

$$\frac{N}{r} :$$

rounded up to next integer of

$$\frac{N}{r}$$

In the encryption of the data Mⱼ, the encryption used is the “substitution table” encryption. Each character is taken as 5 bits which means there are 25=32 possible “characters”.

The incoming digital data is then divided into blocks of five digits and each would be considered as a character. In an embodiment, instead of 5 bits, 4 or 2 bits may also be used. Using 5 bits however provides for having enough complexity without having too many Agents.

Substitution tables may also be embedded in each Agent. An example substitution table is as follows.

f_{J1}
f_{J2}
f_{Jk}

In this case, the Master just transfers the row number to be used for each session. These matrices for each Agent should be independent of each other. Further, the Master has copies of the matrices of each Agent.

In the next step of the algorithm, P_{J+1} and M_{J+1} are passed to the next Agent. The process stops when the next Agent is the Master. The Master checks the parity P_{N} against P₀. If it is verified, the Master decrypts the data M₀ from the encrypted sequence M_{N}.

To illustrate the complexity of the algorithm, it is assumed that f₁, f₂, ...., f_{N} and parity sequence P₀ are securely transmitted to each Agent. There are r! possibilities to map input sequence to output sequence for every Agent. Since there are N independent hierarchical Agents, complexity of (r!)N will have been combined.

Number of possibilities in terms of bits (since each character is 5 bits) is:

$$\# b i t s = 5 ∗ {\text{log}}_{2} {\left(\text{r!}\right)}^{N} = 5 ∗ N ∗ {log}_{2} \left(\text{r!}\right) {\text{and Complexity=2}}^{μ}$$

The following table illustrates change of complexity with block size and the number of Agents.

Table

| | | | | | |
|---|---|---|---|---|---|
| r N | 2 | 4 | 8 | 16 | 32 |
| 2 | µ=10 | µ=45 | µ=150 | µ=440 | µ=1.175 |
| 4 | µ=20 | µ=90 | µ=300 | µ=880 | µ=2.350 |
| 6 | µ=30 | µ=135 | µ=450 | µ=1.320 | µ=3.525 |
| 8 | µ=40 | µ=180 | µ=600 | µ=1.760 | µ=4.700 |

FIG. 10 illustrates the hierarchical dissemination of an address/location information of receiver 702 in accordance with an exemplary embodiment of the invention.

As illustrated in FIG. 10, a hierarchical structure of an address includes level 1: country, level 2: country, state, level 3: country, state, city and level 4: the entire postal address. During the delivery process, only level 1 information is provided to intermediary agent 704A in the chain using need to know basis application 810. In the next stage, level 2 information is revealed to intermediary agent 704B using need to know basis application 810. In the ensuing stage, level 3 information is revealed to intermediary agent 704C using need to know basis application 810. At the final stage, intermediary agent 704N is provided the entire postal address of receiver 702 and the shipment is delivered to receiver 702.

For instance, consider a package being shipped from Tokyo, Japan to a person living in Irvine, CA, USA, or a similar scenario. A global server of information sharing system 100 has only the “country information” and “the port of entry information”, meaning if a logistics company needs to ship to that country it is only provided with port information of where it needs to ship. When the shipment lands in the country, need to know basis delivery protocol 812 shares the information of which city the shipment needs to be sent to. When the shipment arrives at the city where it is supposed to go, need to know basis delivery protocol 812 shares more detailed information on a need to know basis.

Thus, at every stage of delivery chain network 700, an intermediary agent is provided information of receiver 702 only on a need to know basis, thus improving privacy in delivery chain network 700.

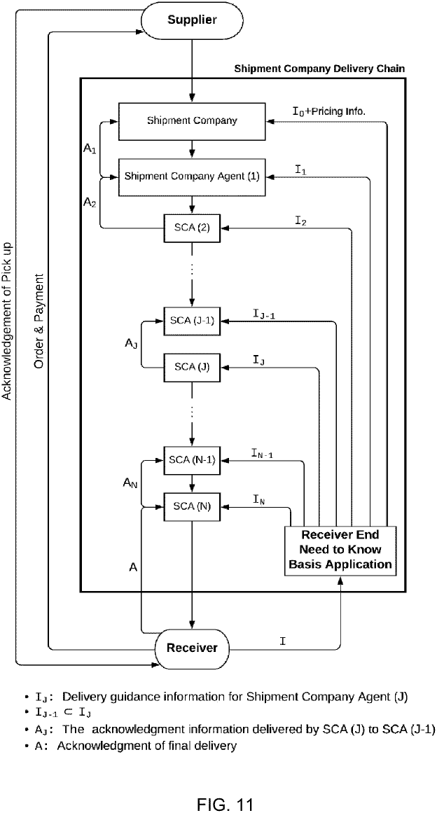

FIG. 11 illustrates algorithmic steps for dissemination of information pertaining to a receiver in a shipment company delivery chain in accordance with another exemplary embodiment of the invention.

As illustrated in FIG. 11, the receiver places an order for goods from a supplier over the internet and pays for the goods. The receiver then requests that an information or parcel be delivered to him/her originating at a point of pick-up from a shipment company.

The delivery guidance information is then generated at the receiver’s end using delivery guidance generator module 808 and the delivery guidance information is made available to shipment company agents of the shipment company to enable the service in a hierarchical manner using need to know basis application 810 at the receiver’s end.

Referring to FIG. 11, there are a chain of shipment company agents SCA1-SCAn for the goods to be delivered from a sender to the receiver,

$$\text{Sender>SCA1>SCA2>SCA3} \text{.} \text{.} \text{.} \text{.} \text{.} \text{.} \text{.SCAn>Receiver}$$

At each stage, a shipment company agent authenticates the information from beginning to their level, signs it with their own digital and sends it to the next delivery agent as per the delivery guidance information generated, using need to know basis delivery protocol 812.

In the last step, the receiver authenticates the information or parcel and signs it with their digital signature using need to know basis delivery protocol 812. To end the delivery process, the acknowledgement of the authenticated information or parcel is received, and the sender is informed through the system in a back-propagation manner via back-propagation module 814 through the same hierarchical chain of agents.

To illustrate the back-propagation step: Agent SCA_i+1 informs Agent SCA_i that SCA_i+1 had been provided with the information that the package has been delivered to the receiver. This is required for the acknowledgment of the final delivery information on a “need to know basis” without ever sharing the receiver’s private information with any intermediary shipping company agent.

At any stage, if there is any problem about the authenticity of the information or the parcel, the hierarchical chain of agents is kept responsible in a backward propagation manner to identify the point where a problem occurred. Such a chain of authentication may put a stop to any further steps and revert to the previous level where the problem was identified.

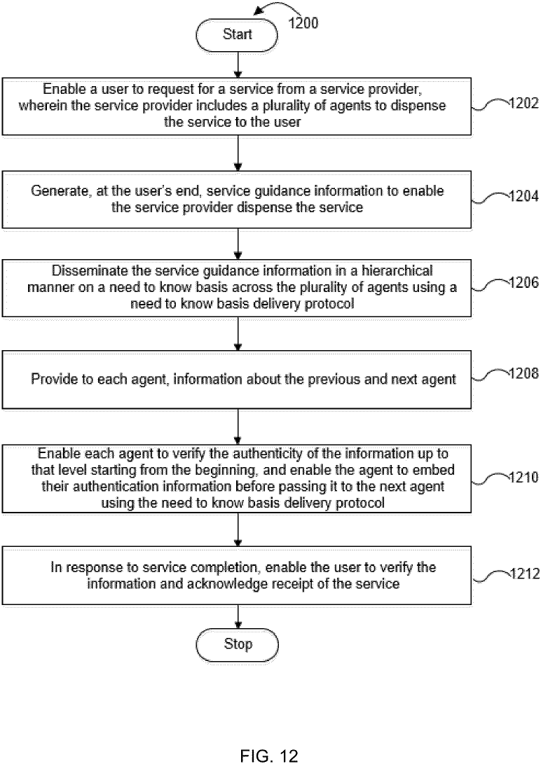

FIG. 12 illustrates a flowchart of a process 1200 for dissemination of information pertaining to a user on a need to know basis while providing a service to the user in accordance with an embodiment of the invention.

As illustrated in FIG. 12, at step 1202, the user requests for a service from a service provider. The service provider includes a plurality of agents for dispensing the service to the user.

At step 1204, service guidance information is generated at the user’s end to enable the service provider to dispense the service to the user. The service guidance information includes, but is not limited to, location/address information and phone number of the user, an available time of the user and other relevant information.

At step 1206, the service guidance information is disseminated in a hierarchical manner on a need to know basis across the plurality of agents using need to know basis delivery protocol.

At step 1208, each agent of the plurality of agents is also provided information about the previous and next agent.

In an ensuing step 1210, each agent verifies the authenticity of the information up to that level starting from the beginning, and each agent embeds their authentication information before passing it to the next agent using the need to know basis delivery protocol.

Finally, at step 1212, upon service completion, the user verifies the information received and acknowledges receipt of the service.

FIG. 13 illustrates a delivery system 1300 for facilitating delivery of products/services to a user in accordance with an embodiment of the invention.

As illustrated in FIG. 13, delivery system 1300 includes a memory 1302 and a processor 1304 communicatively coupled to memory 1302. Memory 1302 and processor 1304 further communicate with various modules of information sharing system 300 via a communication module 1306.

Communication module 1306 may be configured to transmit data between modules, engines, databases, memories, and other components of delivery system 1300 for use in performing the functions discussed herein. Communication module 1306 may include one or more communication types and utilizes various communication methods for communication within delivery system 1300.

Delivery system 1300 further comprises a chain of delivery agents 1308 associated with a service provider and a network of TDAs 1310. Network of TDAs 1310 is selected from a plurality of agents proximate to a delivery location of the user. In accordance with an embodiment, network of TDAs 1310 is selected from a group of neighborhood small businesses, a household, mobile distribution network, and any local qualified party willing to be assigned as TDA, proximate to a delivery location of the user. Network of TDAs 1310 acts as an integral part of common parcel and other delivery services. The network of TDAs 1310 takes over the First Mile and the Last Mile of a delivery supply chain.

In accordance with an embodiment, delivery system 1300 further includes a system operator 1312 configured to authorize a candidate TDA for making deliveries in the delivery system based on the candidate TDA satisfying one or more requirements. The one or more requirements include, but need not be limited to, providing basic training to the candidate TDA for delivery handling, certification of utilization of software provided by system operator 1312, providing enough physical temporary storage area, providing sufficient personnel, insurance coverage for possible losses due to negligence and a limited performance bond to cover possible losses as a result of negligence.

Delivery system 1300 further includes an information sharing system 1314 which includes a database system 1316 comprising one or more databases working in coordination with information sharing system 1314. Database system 1316 is configured to store one or more unique information bundles for a user. The one or more unique information bundles include one or more TDA IDs which includes information associated with one or more TDAs in network of TDAs 1310.

Information sharing system 1314 further includes an information sharing module 1318 which is configured to share the one or more TDA IDs corresponding to the one or more TDAs selected by the user from network of TDAs 1310. Information sharing module 1318 is further configured to share the one or more TDA IDs with one or more delivery agents in chain of delivery agents 1308.

In accordance with an embodiment, a TDA enables transfer/delivery of cash from the user’s funds transfer account to a recipient. The funds transfer account can be, but need not be limited to, a credit card account, a bank account, a debit card account and a gift card account.

In accordance with an exemplary embodiment, to remedy the so-called First Mile and Last Mile problem in the delivery industry, delivery system 1300 utilizes network of TDAs 1310 for the final delivery of packages/parcels to a receiving party or consumers.

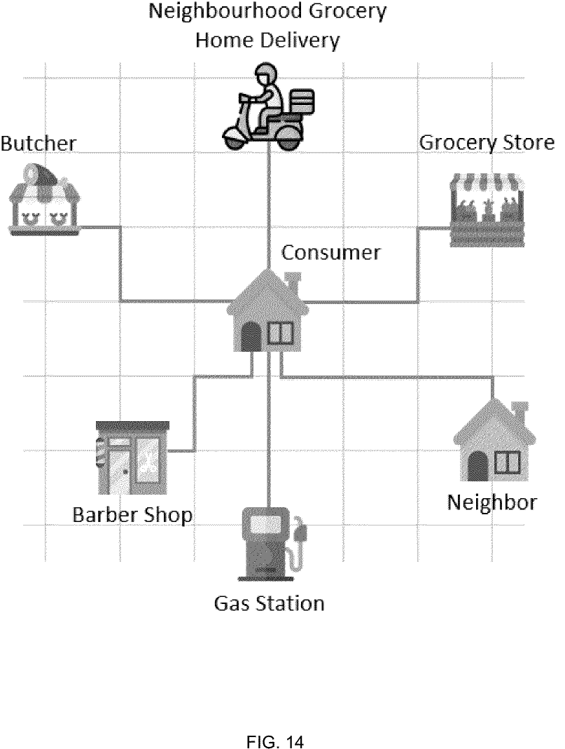

FIG. 14 illustrates a schematic depiction of a TDA in accordance with an embodiment of the invention.

As illustrated in FIG. 14, network of TDAs 1310 are appointed by recipients/consumers to make their final deliveries for them. Ordinarily, these TDAs are existing neighborhood small businesses that the consumers customarily utilize for their daily needs, such as, but not limited to, neighborhood grocery stores, gas stations, bakery, or a store started up just to serve as a TDA.

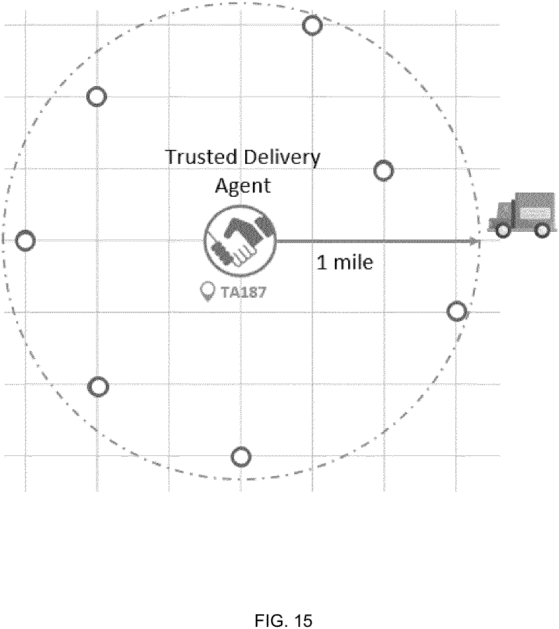

FIG. 15 illustrates a schematic depiction of a TDA as the First Mile and Last Mile solution in accordance with an exemplary embodiment of the invention.

As illustrated in FIG. 15, a service range for a TDA can be less than 500 meters, providing service for less than 2000 customers within a 1-mile radius, for instance. Thus, a TDA is used to avoid missed deliveries, returns, losses and burdensome schedule of couriers and provides deliveries for the same locations every day.

A consumer’s exact delivery information is made available to a TDA using information sharing module 1318 or the TDA naturally has such knowledge about the consumer since they are in the same neighborhood and physically interact for their natural daily transactions. TDAs are also set up for different purposes such as, but not limited to, delivery to a consumer’s house, business, summer house, and for drone deliveries.

Using information sharing module 1318, TDA IDs associated with TDAs are shared for final delivery of a shipment/parcel to a consumer and for drone deliveries. For example, air traffic approaching coordinates embedded in a TDA ID are used as a part of information sharing for drone deliveries.

In accordance with an embodiment, TDAs are included as partners of delivery system 1300 and are “crowd sourced” through delivery system 1300. The TDAs are authorized by an end user and will have to be comply with the standards approved and set by delivery system 1300 to start functioning as TDAs. This provides a huge leverage to delivery system 1300 over TDA partners and courier companies. Thus, delivery system 1300 utilizes network of TDAs 1310 to provide the solution and remedy to the First Mile and the Last Mile problem.

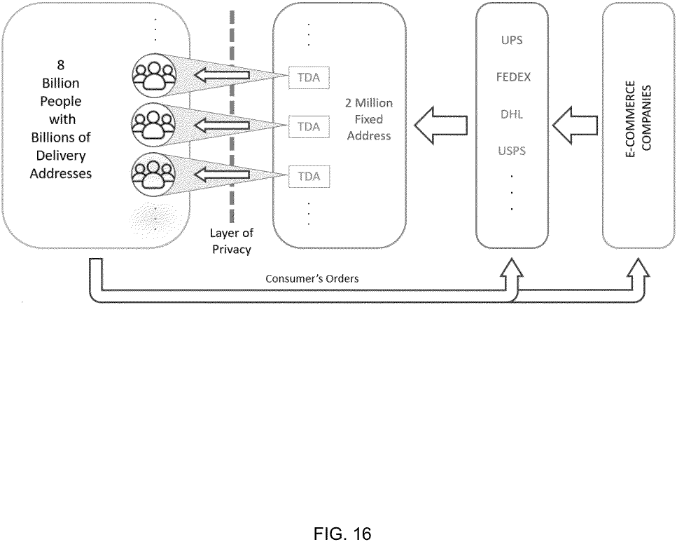

FIG. 16 illustrates a TDA solution in a delivery network in accordance with an embodiment of the invention.

As illustrated in FIG. 16, the TDA property transforms community small businesses such as, but not limited to, the grocery shop, the tailor, the butcher, the baker, or a shop just founded for this purpose, into “the unified Last Mile and First Mile solution partner” for all the players in the courier industry. Through delivery system 1300, a shipper, a receiver and a courier company are “enabling” and “authorizing” TDAs to pick up deliveries from courier service industries such as, but not limited to, DHL, FedEx, UPS, PTT, and the authorization is being done by the recipient through delivery system 1300.

TDA partners are authorized by users of delivery system 1300 to pick up and make the First Mile and the Last Mile delivery to the users for a minimal service charge, which is much less than their cost for the First Mile and the Last Mile. TDA partners then derive a financial benefit from end users of delivery system 300 from the courier service industries (FedEx, DHL, UPS, ATS), since they are taking over the First Mile and the Last Mile responsibility of these industries and reducing the cost incurred by them significantly.

Network of TDAs 1310 also has a TDA package that is a fully integrated component of delivery system 1300. Network of TDAs 1310 eliminates the First Mile and the Last Mile problem for the shipper and the receiver and provides complete personal privacy for the receiver. Network of TDAs 1310 also enables community small businesses to have a new and significant income if they sign up with delivery system 1300 as a TDA.

Once a consumer shows an interest to select a small business as their TDA, the small business is invited by system operator 1312 to become an authorized TDA for making parcel deliveries and is asked to satisfy some requirements to enable them to serve as a TDA. Candidate TDAs are technologically enabled and get networked with delivery system 1300 by system operator 1312. These requirements would include, for example, basic training for delivery handling, certification of utilization of the software provided by system operator 1312, providing enough physical temporary storage area, providing sufficient personnel, insurance coverage for possible losses due to negligence and a limited performance bond to cover possible losses as a result of negligence. After the small business fulfills the requirements, it will be admitted into delivery system 300 as a TDA for a limited number of consumers in a defined neighborhood, such as in a one-mile radius.

Information sharing module 1318 then enables communication among delivery courier services, a recipient, and a TDA. After delivery system 1300 has the consumers, TDAs, courier companies and online shopping sites, the shipping process begins from the online shopping sites and is finalized in a TDA or alternatively, the shipping process starts from a consumer and is finalized in a TDA for the receiving consumer.

In accordance with an embodiment, a natural result of need to know basis delivery protocol 322 implementation in information sharing module 1318 is that, when a shipment is to be initiated (sending end) from Location A to Location B, the exact/optimal routing information and pricing is generated at the “receiving end” since the sender is not provided with the detailed final location information of the receiver. For instance, if it is an international shipment, the courier services at the sending end know of only the country of the receiver. At this stage, since the courier services do not have knowledge of the state, city, district, village or any other information, they are unable to figure out the chain of logistics intermediaries to be used to go from Location A to Location B.

When a request is received from a consumer, the optimal routing information to deliver the parcel to the consumer is generated at the receiver’s end and is distributed to all of the intermediaries on a need to know basis using the need to know basis delivery protocol. If there is a need to revise the optimal routing information for any reason, the revision is also done at the receiving end point (receiving end). Also, the pricing for the shipment is also done in the courier service’s system at the receiving end and communicated to the shipping party. As such, two targets are achieved. Firstly, the personal private information of the consumer is held confidential. Secondly, the optimal routing information is provided as a part of the information shared by information sharing module 1318, which will prevent shipments from getting stuck at wrong logistics points.

In an embodiment, the First Mile problem is resolved for a group of cases. In one case, the First Mile problem that is dealt with is that when the consumers wish to initiate a shipment, they need to go to the collection points or stores of courier companies, which is mostly undesirable for consumers. On the other hand, going out to pick up a new shipment or a returned/refused shipment is a very costly process for the courier companies. A straightforward method of solving this First Mile Problem is to use TDAs as pick-up points for the new shipments and returned/refused shipments.

To resolve the Last Mile problem, consumers ask courier companies for their packages to be delivered to a “final address”, that is, to the TDAs. A courier company makes final deliveries to the very same TDAs every day, hence there is no time consumed in searching for the location and person for the delivery of every package. During the execution of an online purchase and shipping process, the following contracts are entered into:

A contract between the consumer and the online seller: This contract includes the item purchased and corresponding payment to be made and allows the courier company to pick up the package after the payment is done. Unless the consumer returns the purchased goods for some reason, the contract is fulfilled when the package is delivered to the courier company.

A contract between the consumer and the courier company: This contract includes picking up the package from the seller (or the sender in case it is a consumer-to-consumer shipment) after the ordering consumer makes the payment. The contract is fulfilled when the courier company delivers the package to the TDA of the consumer.

A contract between the consumer and the TDA: This contract indicates that the TDA receives the goods from the courier company on behalf of the consumer and is responsible for the well-being of the package after it is received by them. The TDA’s contract is fulfilled when the consumer either picks up the package from the TDA or the TDA delivers the goods to the consumer upon their request through delivery system 1300.

As soon as the package is delivered to the TDA, the courier company fulfills its “contract” with the consumer for delivery since the consumer asked for the delivery to be made to the TDA. At that moment, the consumer is sent a message though a messaging system that their package has been delivered to the TDA as per their demand. The consumer can opt to ask the TDA to deliver the package to their location, which is known by the TDA, or the consumer can go and pick up the package from the TDA. At this stage of the delivery process, the “contract” between the TDA and the consumer is in effect. All these contracts are entered into through delivery system 300. In all these cases, the consumer pays a nominal service charge for the services of the TDA.

In an embodiment, if a consumer is not happy about the shipment they received and wishes to return it, the consumer can hand it over to the TDA and the TDA delivers the returned parcel to the courier company in their first service when bringing new deliveries to them. Similarly, if the consumer wishes to send a new outgoing shipment, the consumer delivers it to the TDA with the final delivery information and the TDA delivers the parcel as per the consumer’s demand. The consumer can also request the TDA to send their package using a specific courier company or they could leave the choice to the TDA to pick a courier company, in which case the TDA considers several criteria such as, but not limited to, cost, service quality and other incentives provided by the courier company to the TDA and the consumer.

In another embodiment of the invention, there may be cases where the consumer may not want to pick TDAs for their deliveries. In such cases, the TDAs may be available to offer their services to the courier companies for a service fee to make deliveries on behalf of the courier companies under their brand.

Every day, TDAs receive new incoming shipments for their customers as a bulk shipment from each courier company. The TDAs also hand in the return parcels and the new outgoing shipments to the courier truck that brought in the new parcels. Such a process is repeated by every courier company with the same TDAs, that is, the TDAs act as common delivery agents for all competing courier services. As the demand for same day delivery increases, delivery by courier companies through the TDAs is repeated several times every day.

When seasonal surge happens, such as, but not limited to, during Black Friday, Christmas season and other similar occasions, the number of parcels to be delivered increases many folds compared to normal days. In such cases, the delivery industry resources are unable to cope with the surges in the demand. Under such circumstances, the TDA network conveniently handles such surges without any extra investment. This is further illustrated as follows:

On one hand, the TDAs create additional storage area in their store in anticipation of an upcoming surge in incoming and outgoing shipments.

On the other hand, the courier companies make several bulk deliveries every day to finish the large volume of the parcels to be delivered.

The consumer is then able to receive their incoming shipments without delay by picking up their parcels from their own TDAs or asking for delivery to their final locations.

The TDAs are satisfied since they will have much more extra income because of the surge in the number of parcels. The courier companies are also satisfied since they will be able to cope with the surge without any delays in their deliveries or picking up the new shipments.

In accordance with an embodiment, delivery system 1300 also enables unified tracking by enabling the customer/user to track all their incoming and outgoing deliveries from their information sharing account regardless of a sender or carrier.

Further, delivery system 1300 enables the customer to prevent unauthorized deliveries at the source before they are shipped from their information sharing account. Prompts/notifications are sent to the customer regarding shipment to be delivered and delivery is initiated only upon receiving authorization from the customer.

The present invention is advantageous in that it provides an improved information sharing system which addresses the challenges associated with existing address conventions, by encoding all relevant information associated with a user to generate unique information bundles that stored in an information wallet. The unique information bundles identify the user and not the user’s location. Therefore, even if the user’s postal address/location changes, the information can be updated in the unique information bundles. These information bundles are universally applicable as they are not limited by language and format differences and are suitable for verbal transfer.

Furthermore, the invention enables storing addresses with space and time dimensions (4D addresses) as part of the unique information bundles and assigns varying security levels to enable sharing of information associated with the IDs on a contextual or conditional basis.

Further, the invention preserves personal privacy of the user while being able to benefit from the convenience of placing orders and receiving goods over the internet. The need to know basis delivery protocol is designed such that when a person is receiving a service from a third-party service provider, only the minimum amount of information that is required to enable the goods or services to reach that person is made available in each intermediary step. This information only enables the service provider to be able to serve at that stage without revealing anything additional on the customer’s information. The need to know basis delivery protocol enables hierarchical dissemination of the information for effective completion of services or tasks. For instance, the need to know basis delivery protocol enables secure delivery of assets such as, but not limited to, digital information, physical goods and digital money/coin on a need to know basis, and also enables secure execution of financial or commercial transactions on a need to know basis. Other fields of application include, but need not be limited to, parcel delivery, transfer of financial information including transfer of funds via multiple institutions until reaching a final point, and sharing medical information about a patient with different doctors (family doctor, specialist, trusted persons) and insurance agencies. The list in this document is not meant to restrict the applications, but rather to exemplify the concepts.

Furthermore, an important feature of the information sharing system is to store the information in distributed servers where each server stores a part of the information on a need to know basis. The details of every user are naturally kept in the servers in their own country, since the only information needed for outside parties to utilize the unique information bundles of a person is the port of entry in that country.

From an information sharing account, users can perform unified tracking of their deliveries from their account, which enables them to track their incoming and outgoing shipments no matter which courier service is doing the actual delivery. The user can activate an authorization feature in the information sharing system so that no shipment can be initiated without prior authorization of the users. Such a property also prevents delivery of dangerous/illegal shipments. The user can have a requirement for authorization of all incoming shipments or can have a white-list and require that anybody else not on the white-list get authorization before sending a shipment to the user.

Furthermore, the present invention is advantageous in that it provides an improved delivery system which addresses the challenges associated with the First Mile and the Last Mile problem, diverse delivery requests, and changing delivery technologies (for example, drone deliveries).

The present invention utilizes the TDA network to provide a solution and remedy the inefficiencies and difficulties of the First Mile and the Last Mile delivery, thus avoiding missed deliveries, returns, losses and burdensome schedule of couriers. The delivery system comprises a network of TDAs selected from ordinary small neighborhood businesses (selected by the recipient consumers and not by the delivering courier services) and enables TDAs to serve as the First Mile and the Last Mile delivery agents for courier companies. Thus, the TDA network functions as the ‘Uber’ of the delivery industry and the TDAs provide a solution for the First Mile and the Last Mile delivery problem for the parcel delivery industry and ensure a smooth First Mile and Last Mile delivery to e-commerce delivery services. Thus, the shipments/parcels get through the next stages of the C2C or B2C supply chain in a quick, efficient, and hassle-free manner. The TDA network also provides a solution for the same day delivery problem and further replaces the ATM cash delivery system for the banks.

Those skilled in the art will realize that the above recognized advantages and other advantages described herein are merely exemplary and are not meant to be a complete rendering of all of the advantages of the various embodiments of the present invention.

The system, as described in the invention or any of its components may be embodied in the form of a computing device. The computing device can be, for example, but not limited to, a general-purpose computer, a smartphone, a programmed microprocessor, an embedded device, a virtual machine, a distributed computer, a Blockchain system, an Ethereum system, a micro-controller, a peripheral integrated circuit element, and other devices or arrangements of devices, which are capable of implementing the steps that constitute the method of the invention. The computing device includes one or more of the following: a processor, a memory, a nonvolatile data storage, a display, and a user interface.

In the foregoing specification, specific embodiments of the present invention have been described. However, one of ordinary skill in the art appreciates that various modifications and changes can be made without departing from the scope of the present invention. Accordingly, the specification and figures are to be regarded in an illustrative rather than a restrictive sense, and all such modifications are intended to be included within the scope of the present invention.

What is claimed is:

1. An information sharing system, the information sharing system comprising:
a database system comprising one or more databases working in coordination with the information sharing system, the database system configured to store one or more unique information bundles for a user; and
an information sharing module, wherein the information sharing module is configured to share at least one unique information bundle of the one or more unique information bundles with one or more parties, wherein the information sharing module is configured to enable dissemination of information resident within a unique information bundle to the one or more parties selectively when needed.

2. The information sharing system of claim 1, wherein the one or more unique information bundles of the user are stored in an information wallet.

3. The information sharing system of claim 1, wherein a unique information bundle is generated by encapsulating/encoding a plurality of information items associated with the user.

4. The information sharing system of claim 3, wherein the plurality of information items comprise at least one of basic contact information of the user, the user’s images/photos, 3D/4D addresses/coordinates of the user’s location, the user’s biometrics information, images/pictures of the user’s location, building, entrance/door, pictures/videos of the location/landmarks/way points to the user’s location, navigational aids, information about proxy contacts of the user to reach out to in case of difficulty, barcodes, square codes, TDA IDs and Radio Frequency (RF) IDs, and an available time or schedule of the user.

5. The information sharing system of claim 3, wherein at least one information item of the plurality of information items associated with a unique information bundle is updated based on tracking the user’s current location.

6. The information sharing system of claim 3, wherein the information sharing module is configured to share at least one information item of the plurality of information items encapsulated/encoded in a unique information bundle with the one or more parties.

7. The information sharing system of claim 3, wherein the information sharing module is configured to disseminate only a portion of an information item encapsulated/encoded in a unique information bundle on a need to know basis to each of the one or more parties.

8. The information sharing system of claim 1, wherein the information sharing module is configured to share an “Interactive Address”/“Connected Address”/“Live Address” with one or more parties, wherein the “Interactive Address″/“Connected Address”/“Live Address” comprises at least one of a scheduled (time-based) information and an updated location information.

9. The information sharing system of claim 1, wherein the one or more parties comprise at least one of service providers, delivery agents, TDAs, other users, non-users and machines.

10. The information sharing system of claim 9, wherein a TDA is selected by the user from a network of TDAs, wherein the network of TDAs is selected from a group of neighborhood small businesses, a household, mobile distribution network, and any local qualified party willing to be assigned as TDA, to enable either a First Mile or Last Mile delivery.

11. An information sharing system for a delivery network, wherein the delivery network comprises a chain of delivery agents for enabling delivery of a product/service to a user, the information sharing system comprising:
a database system comprising one or more databases working in coordination with the information sharing system, the database system configured to store one or more unique information bundles for a user, wherein the one or more unique information bundles are generated by encapsulating/encoding a plurality of information items associated with the user;
an information sharing module, wherein the information sharing module is configured to share at least one information item encapsulated/encoded in a unique information bundle across the chain of delivery agents, wherein the information sharing module is configured to:
disseminate only a portion of an information item to each delivery agent in the chain of delivery agents on a need to know basis; and
verify the authenticity of the information item for each delivery agent up to that level starting from the beginning and embed authentication information associated with each delivery agent in the at least one information item before passing the at least one information item to a next delivery agent.

12. The information sharing system of claim 11, wherein the chain of delivery agents comprises at least one of a courier service delivery agent and a Trusted Delivery Agent (TDA).

13. The information sharing system of claim 11, wherein the information sharing module is further configured to propagate the information item in a back-propagation manner through the same chain of delivery agents on a need to know basis.

14. A delivery system for facilitating delivery of products/services to a user, the delivery system comprising:
a network of Trusted Delivery Agents (TDAs), wherein the network of TDAs is selected from a plurality of agents proximate to a delivery location of the user; and
an information sharing system, the information sharing system comprising:
a database system comprising one or more databases working in coordination with the information sharing system, the database system configured to store one or more unique information bundles for a user, wherein the one or more unique information bundles comprise one or more TDA IDs, wherein a TDA ID corresponds to information associated with a TDA in the network of TDAs; and
an information sharing module, wherein the information sharing module is configured to share at least one TDA ID of the one or more TDA IDs, wherein the at least one TDA ID corresponds to one or more TDAs selected by the user from a network of TDAs.

15. The delivery system of claim 14, wherein the network of TDAs is selected from a group of neighborhood small businesses, a household, mobile distribution network, and any local qualified party willing to be assigned as TDA, proximate to a delivery location of the user.

16. The delivery system of claim 14, wherein the network of TDAs acts as an integral part of common parcel and other delivery services, wherein the network of TDAs takes over the First Mile and the Last Mile of a delivery supply chain.

17. The delivery system of claim 14 further comprises a system operator configured to authorize a candidate TDA for making deliveries in the delivery system based on the candidate TDA satisfying at least one requirement, wherein the at least one requirement comprises at least one of providing basic training to the candidate TDA for delivery handling, certification of utilization of software provided by the system operator, providing enough physical temporary storage area, providing sufficient personnel, insurance coverage for possible losses due to negligence and a limited performance bond to cover possible losses as a result of negligence.

18. The delivery system of claim 14, wherein the delivery system further comprises a chain of delivery agents associated with a service provider, wherein the information sharing module is configured to share at least one TDA ID of the one or more TDA IDs with at least one delivery agent in the chain of delivery agents.

19. The delivery system of claim 14, wherein a TDA enables transfer/delivery of cash from the user’s funds transfer account to a recipient, wherein the funds transfer account is at least one of a credit card account, a bank account, a debit card account and a gift card account.
